(19) United States
(12) Patent Application Publication
(10) Pub. No.: US 2012/0066056 A1
(43) Pub. Date: Mar. 15, 2012

(54) Advertising Revenue Sharing System and Method

(75) Inventor: Shawn M. Meehan, Carson City, NV (US)

(73) Assignee: VITALSTOCKS LLC, Carson City, NV (US)

(21) Appl. No.: 13/226,592

(22) Filed: Sep. 7, 2011

Related U.S. Application Data
(60) Provisional application No. 61/381,721, filed on Sep. 10, 2010.

(51) Int. Cl. G06Q 30/00

(52) U.S. Cl. 705/14.46

(57) ABSTRACT

A revenue sharing system includes a destination website in communication with an analytics module. The system also includes a payment calculation module, capable of communication with the analytics module. One or more referring websites direct a visitor to the destination website in response to the selection of a link. The analytics module tracks visitor activity and relates the activity to a referrer account, based on the link. The payment calculation module calculates a payment based at least in part on visitor activity. The destination website transmits the calculated payment to a payment account associated with the referrer account.

### CROSS-REFERENCE TO RELATED APPLICATIONS

This application claims the benefit of U.S. Provisional Application No. 61/381,721, filed Sep. 10, 2010. The disclosure of which is incorporated in its entirety by reference herein.

### BACKGROUND

Many informational web sites display widgets and other types of links directing readers to articles on another website, thereby adding value for readers on a specific topic. Such informational websites either pay third-party services to compile and format these links or display free widgets containing this content.

### SUMMARY

In a first illustrative embodiment, a revenue sharing system includes a destination website in communication with an analytics module. The system also includes a payment calculation module, capable of communication with the analytics module. In this embodiment, one or more referring websites direct a visitor to the destination website in response to the selection of a link. The analytics module tracks visitor activity and relates the activity to a referrer account, based on the link.

Also, in this embodiment, the payment calculation module calculates a payment based at least in part on visitor activity. The destination website transmits the calculated payment to a payment account associated with the referrer account.

In a second illustrative embodiment, a computer-implemented method includes receiving a request to access pages, at a destination website, from a visitor sent by a referring website. The method also includes tracking activity of the visitor on the destination website, and relating the tracked activity to a referrer account associated with the referring website.

Also, the method includes calculating a payment for the referrer account, based on the tracked activity, and transmitting the payment to a payment destination associated with the referrer account.

In a third illustrative embodiment, a computer implemented method includes receiving a request from a party wishing to provide referrals to a website. The method includes creating a new referrer account for the requesting party and providing the requesting party with at least one link through which referrals may be generated. The illustrative method further includes tracking activity of visitors sent to the website via the at least one link.

The method also includes calculating a payment to be rendered to the party based at least on tracked activity and remitting the calculated payment to the party.

### BRIEF DESCRIPTION OF THE DRAWINGS

The figures identified below are illustrative of some embodiments of the invention. The figures are not intended to be limiting of the invention. The embodiments, both as to their organization and manner of operation, together with further object and advantages thereof, may best be understood with reference to the following description, taken in connection with the accompanying drawings, in which:

FIG. 1 is an exemplary illustration of an advertisement revenue sharing system;

FIG. 2 is an aspect of the ad revenue sharing process according to one of the various embodiments;

FIG. 3 illustrates a process for tracking visits to a destination site as part of the ad revenue sharing process;

FIG. 4 illustrates a process for determining the amount of ad revenue to share with referring websites; and

FIG. 5 is an exemplary screenshot of an ad revenue sharing website.

### DETAILED DESCRIPTION

Detailed embodiments of the invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for teaching one skilled in the art to variously employ the present invention.

Many informational web sites display widgets and other types of links directing readers to articles on another website, thereby adding value for readers on a specific topic. Such informational websites either pay third-party services to compile and format these links or display free widgets containing this content.

Producers/publishers of current widget systems and the informational websites on which the widgets are placed, such as financial websites and financial blogs, may not share revenue. Typically, online sites charge the publisher a fee for gathering and displaying the content. This fee can be paid directly to the informational website or through an intermediary which insures that the links are published on multiple websites on the intermediary's network. However, there is no other incentive for the host to promote the publisher's information.

One revenue sharing model is the “cost per click” model in which revenue is shared on a per click basis. In most cases the revenue that is shared is advertising revenue. As an example, in the cost-per-click model, web entity A, which generates revenue from advertisements, may pay web entity B, which provides a link to site A's content, a predetermined amount (e.g., 10 cents) per click by a visitor.

Another known model is the “cost per lead” model. In this model, a certain amount of revenue is provided to a referral site (e.g., site B in the above example) for specific action being taken on the destination website, such as signing up for a newsletter (e.g., site A in the above example). In some cases, the revenue that is shared may be revenue from a particular action, such as a purchase. Thus, another model is the “cost per action” model. In this model, the referral site may not receive a share of the revenue until a purchase is made on the destination website.

Advertising via a text link can be a source of revenue for a referring site. For example, one or more links may be placed on the referring site which links to a destination site. The revenue generated by the destination site, which may come from advertising on the destination site, may be shared with the referring site, thereby generating revenue for the referring site. Advertising as a revenue source is not a limiting revenue source. Accordingly, a destination site may receive revenue from other revenue sources without departing from the scope of the invention. Thus, the traffic generating websites (e.g., the referring site) hosting the link(s) to the destination site is provided a portion of the revenue generated due to a visit from one or more visitors referred from the referring site. Further, this exchange removes the “middle man” entity that serves to collect the portion of the revenue from the paying site (e.g., the “payor”) and give the portion of the revenue to the site being paid (e.g., the “payee”). As used herein in one or more non-limiting embodiments, a “destination site” may be a site to which visitors are referred from a “referring site” visited by the visitor.

One or more embodiments relate to a revenue sharing model in which a referring website is paid by a destination website a certain portion (e.g., and without limitation, a percentage) of the total revenue earned by the destination website. In some embodiments, the revenue may be determined based on the number or percentage of page views by each distinct visitor to the destination website from the referring website. The referring website may be a syndication of referring websites. Advantageously, such a revenue sharing system provides useful insight into the value of the content on the destination site based on the number of page views by each visitor. Additionally, the system may indicate that actual traffic is being generated on the destination site as opposed to “accidental” traffic such as an accidental click on a link by a visitor on the referring site directing the visitor to the destination site.

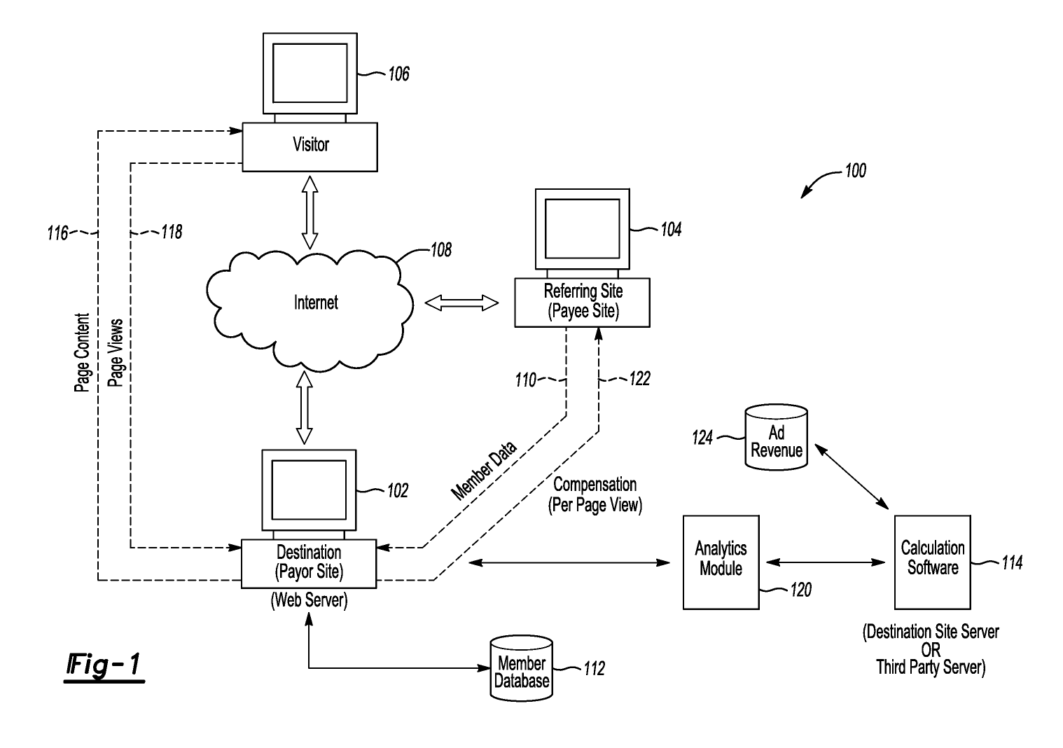

FIG. 1 illustrates a system 100 capable of sharing revenues made by a destination site with one or more referring sites. The revenue made by a destination site (also referred to herein as a “payor” site) 102 may partially or wholly be based on advertising revenue. The fee arrangement made between advertisers and the destination site 102 may be prearranged and vary according to the business agreement executed between the advertisers and the destination site. The destination site 102 may be an online website that provides services, reference information, and/or advice to visitors of the destination site 102. For example, site 102 may be a financial blog and/or other site providing financial services, reference and/or advice. While the various embodiments are described herein within the context of the financial services industry, this is provided by way of example only. The various embodiments may be used as a revenue sharing system in other industries (e.g., and without limitation, media, real estate, legal, and medical).

The destination site 102 may pay a referring site 104 a portion of the revenue received by the destination site 102 based on a number of page views on the destination site 102 by a visitor from a visitor terminal 106. The visitor terminal 106 may be any data processing device including, but not limited to, nomadic devices (e.g., and without limitation, mobile phones, PDAs, personal media players, laptops) and/or personal computers. The visitor terminal 106 may be a device capable of communicating over the Internet 108 with the referring site 104 and/or the destination site 102.

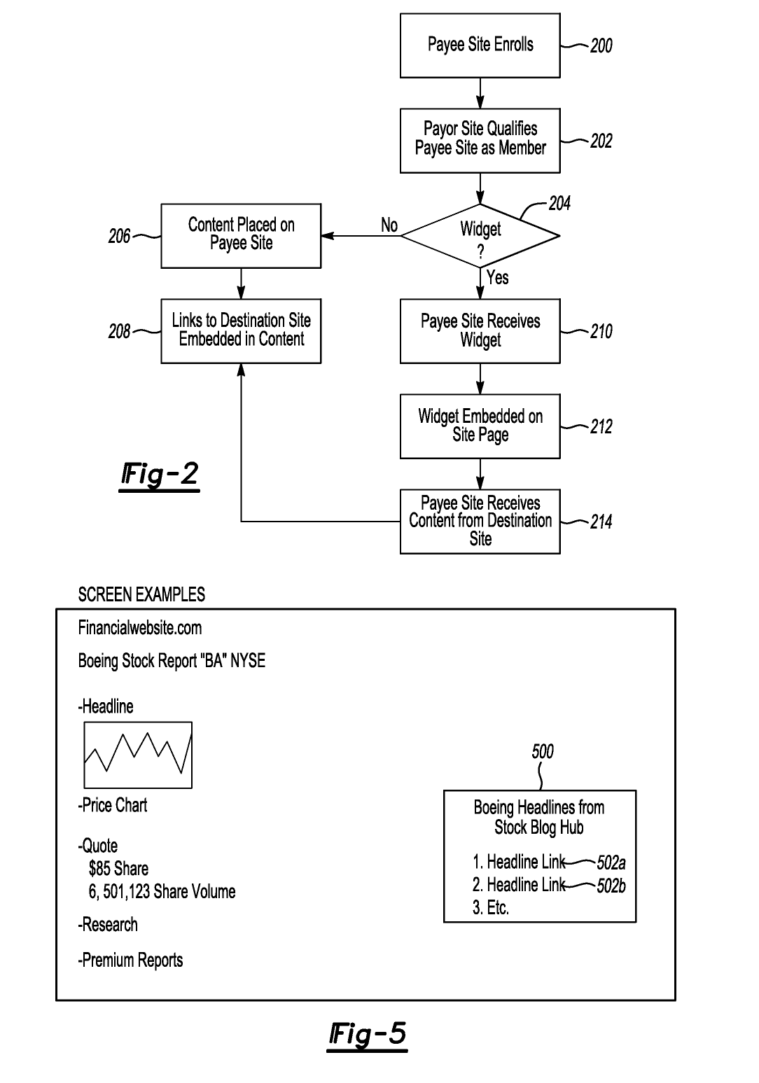

In order to receive referral payments/compensation from the payor 102, the referring site 104 (herein also referred to as the “payee” site) may be required to register with the payor 102. Once registered, the payee 104 may become a member of a syndication of referring sites/payees 104. The registration process may include creating a profile for the payee-member 104 including, but not limited to, entity name, entity contact information, and the like. The registration and approval process for the payee 104 will be further described in detail with respect to FIG. 2 below.

Member data 110 of a registered payee may be transmitted from the referring site 104 to the destination site 102 in order to store the payee member in a membership database 112. Member profile information may be transmitted once, for example, upon registration. During a visit by a visitor 106, a payee identifier assigned to the member payee 104 by the destination site 102 upon registration may be transmitted as member data 110. One non-limiting example of such an identifier is a tracking code. This tracking code may be appended to a URL. The tracking code may be a series of numbers, letters, or a combination of numeric and alphabetic characters. Alternatively, the identifier may be the payee member's URL (e.g., without a tracking code). Certainly, other payee identifiers may be used and the examples provided above are for illustration.

In some embodiments, the member database 112 may include tracking information for each visit and re-visit by a visitor. In some embodiments, the tracking information may be stored in a separate database, such as, but not limited to, a visitor database (not shown), that is in communication (e.g., and without limitation, relational communication) with the member database 112. However, for clarity, the various embodiments are described in the context of the information being stored in the member database 112. The information may include, but is not limited to, the date of a visit and/or re-visit and/or the number of visits and re-visits. The information may also include information identifying the visitor 106. As a non-limiting example, a cookie identifier (for tracking a cookie stored on the visitor terminal 106) may be stored in the member database 112. Of course, other visitor identifiers may be used without departing from the scope of the invention. By way of example and not limitation, when a visitor visits the destination site 102 via the referring site 104, the visit date may be stored in association with the payee member 104 in the member database 112. If the visitor subsequently re-visits the destination site 102, each subsequent visit date may be stored in the database 112 signifying that the visitor has re-visited the destination site 102. Additionally or alternatively, the number of visits may be stored in the database 112 signifying a visit or re-visit by the visitor.

As will be further described below, each visitor may be associated with the member identifier (e.g., and without limitation, a tracking code or URL) in the member database 112 (or the separate visitor database). This association may be used to identify the most recently visited member through which the visitor 106 arrived at the destination site 102. The most recently visited payee member 104 may receive compensation for each re-visit to the destination site 102 by the visitor 106.

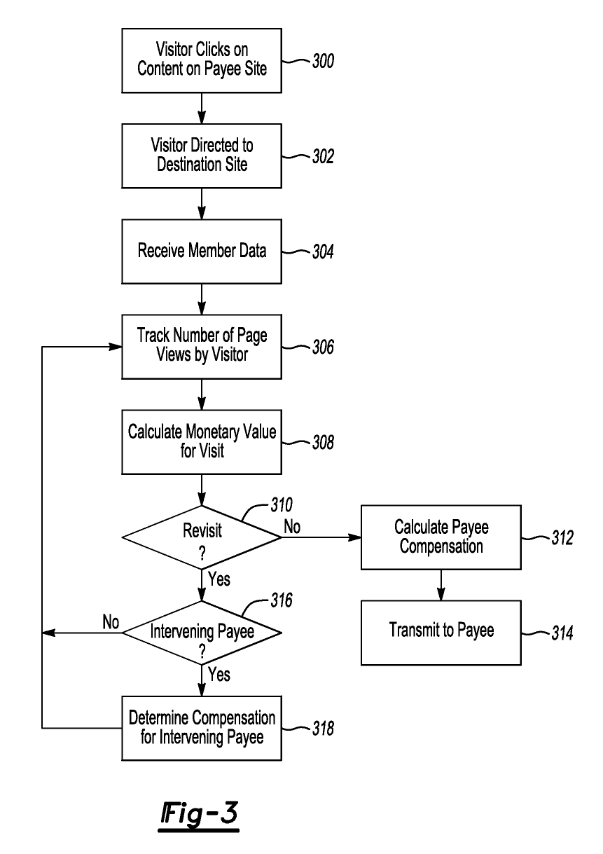

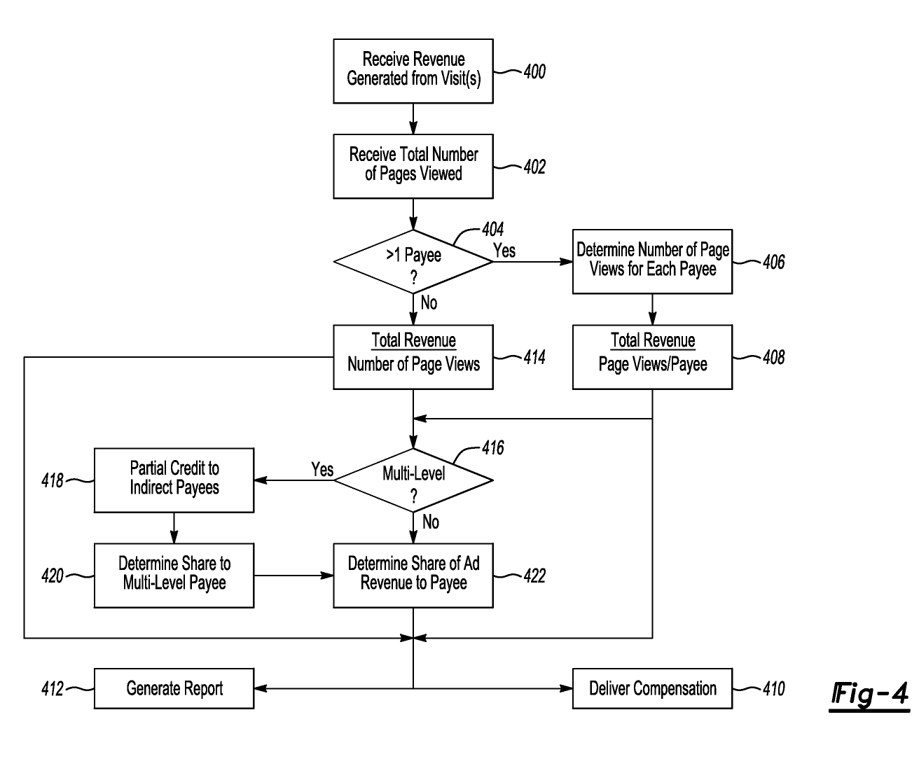

The destination site 102 may be a server that is configured with revenue calculation software 114. The server may be a web server, an application server, or both. In some embodiments, there may be a separate revenue calculation server (not shown) hosting the software 114 and a web server communicating with the calculation server. However, for clarity of description, the destination site 102 is described as a server performing the web services and the revenue calculation. Further details of the revenue calculation process will be described below with respect to FIGS. 3 and 4.

As illustrated in FIG. 1, when the visitor 106 is directed to the destination site 102 (via the referring site 104), the destination site 102 serves page content 116 to the visitor. During or after the visit, the number of page views 118 may be transmitted to the destination site 102, an analytics module 120 or other appropriate record keeping location. In some embodiments, the number of page views may be transmitted simultaneously with the transmission of page content. The number of page views may be stored in memory of the destination site 102 and used by the calculation software 114 for calculating the compensation to the payee 104. In some embodiments, the number of page views may be stored in the member database 112. As used in the various embodiments described, a page view may comprise each page that the visitor views. In some embodiments, a page view may comprise each distinct page that the visitor views.

In order to tabulate the number of page views, an analytics module 120 may be used by the system 100. The analytics module 120 may be hosted by the destination site 102 or hosted by a third party. An example of a third-party web analytics module is the GOOGLE ANALYTICS module. Where the analytics module 120 is hosted by the destination site 102, the calculation software 114 and the analytics module 120 may be a single module or separate modules. Where the analytics module 120 is hosted by a third-party, the destination site may include an application programming interface (API) to enable communication with and operation of the third-party service.

As will be further described below with respect to FIG. 4, the calculation software 114 may use the number of page views as input, along with other inputs (further described below), to determine the compensation 122 to the payee site 104. On a periodic basis (e.g., when a revenue determination is made or at particular time increments such as daily, weekly, or monthly), the calculation software 114 may receive ad revenue information 124 such as the monetary amount of ad revenue generated by the destination site. The ad revenue information may serve as a basis by the calculation software 114 in determining the amount of compensation 122 provided to the payee site 104. The ad revenue information may be stored in memory of the destination site 102 or in separate memory capable of communicating with the calculation software 114. In some embodiments, the ad revenue information may be stored in one or more spreadsheets or databases (hereinafter referred to as data storage 124). The ad revenue information stored in data storage 124 may be input and updated manually or automatically on a periodic basis. For example, an administrator at destination site 102 may manually input the information. Alternatively or additionally, separate software may be used to automatically monitor and calculate the amount of revenue generated at the destination site 102.

FIG. 2 illustrates the process for enabling compensation to be paid to the payee site 104. It will be appreciated that the disclosure and arrangement of FIG. 2 may be modified or re-arranged to best fit a particular implementation of the various embodiments of the invention.

As described above, the payee site may be required to become a member of the syndication of payee sites. Accordingly, the payee entity may enroll in the ad revenue sharing program (block 200). Enrollment may occur directly from the destination site 102. In some embodiments, the site seeking to become a referring site 104 may be directed to the destination site 102 for enrollment in response to clicking a link on another referring site. For example, a link on a referring site 104 may say, “Get paid to host this widget.” The site seeking to become a referring site may click on this link to download the widget to the site. When a referring site or destination site is described herein as performing an action (e.g., clicking on a link), the action may be performed by an individual associated with the site.

In some embodiments, in response to clicking on this link, at least some of the information about the payee member may be transmitted to the destination site. This information may include, but is not limited to, the entity's name and the URL. Accordingly, the referring site 104 may only be required to manually input a partial profile.

The payor site 102 may qualify the payee site 104 for the revenue sharing program based on the registration information (block 202). As part of the qualification process, in some embodiments, the destination site 102 may transmit to the referring site 104 a tracking code. When the visitor 106 visits the destination site 102, the tracking code may be used to identify the payee 104.

A visitor may either select a link on a widget placed on the referring site 104 and/or select a link embedded in the content displayed on the referring site 104. As an example of the latter arrangement, the link may be placed in an informative article. As another non-limiting example, the link may be embedded in a message on a social networking website or associated with a link on a social networking website (e.g., and without limitation, a link enabling content to be distributed within a social network when one or more users click on the link, such as a “like” button used on FACEBOOK). As other non-limiting examples, the link may be transmitted through electronic mail (including chain electronic mail), message boards, and other like communication. In some embodiments, the link may also be communicated partly using non-electronic communication. For example, and without limitation, a visitor may visit the destination site 102 after being given a handwritten note with the destination site address 102. The visitor may input the tracking code associated with the referring entity 104 at the destination site 102.

FIG. 5, which is an exemplary graphical user interface (GUI) of the referring website, provides an example of a widget 500 which includes one or more headline links 502 a, b from “FinancialBlog.com.” When the visitor clicks on at least one of link 502a and/or b, the visitor 106 may be directed to the destination site 104 (in this case, “financialblog.com”).

In some embodiments, the content displayed in widget 500 may correlate with the content of the referring website 104. For example, in this case illustrated in FIG. 5, the visitor 106 is viewing the BOEING Stock Report on financialwebsite.com. Accordingly, the widget 500 displays articles on financialblog.com (e.g., the destination site 102) relating to BOEING. The widget 500 may include logic to identify particular keywords or other identifying information on the referring site 104 that matches content on the destination site 102. In one non-limiting embodiment, the widget may be programmed to detect one or more tags associated with the referring site. A tag may be descriptive metadata associated with the referring site. Non-limiting examples may include ticker symbols or descriptive terms.

Based on a match of the identifying information, the links 502a, b to the relevant articles may be displayed in the widget 500. In further embodiments, if there is no direct match, then the links 502a, b may direct the visitor to information that is relevant to or related to the content displayed on the referring site 104. For example, if the destination site 102 does not have articles relating to BOEING, links to articles relevant to the aerospace industry, in general, may be displayed. As another example, the links may display articles relating to subject areas or names disclosed in the content on the referring site 104. In some embodiments, the links may be RSS feeds from the destination site.

Using content-based advertising for the destination site 102 can be advantageous for the destination site 102. For example, in addition to directing visitors to the destination site 102, the text links can also enhance search engine optimization (SEO) for the destination site 102.

The widget may be downloaded for placement on the referring site 104. In some embodiments, the source code may be transmitted to the referring site 104 (e.g., from an administrator of the destination site 102 to an administrator of the referring site 104) and manually programmed to the referring site 104. Referring back to FIG. 2, a determination may be made if the payee 104 desires the widget 500 (block 204). If the payee 104 does not desire a widget, the payee may place content on the site (block 206), such as an informative article, and embed a link in the informative article linking to the destination site 102 (block 208).

If the payee desires to place a widget 500 on the site 104, the payee may receive the widget 500 (block 210) and may embed it on the site (block 212) as illustrated in FIG. 5. The payee 104 may receive the content (e.g., and without limitation, as an RSS feed) for display as a link to the destination site 102 (block 214). As described above, the links may or may not correlate with the content on the referring site 104 being viewed by the visitor.

FIG. 3 illustrates the process for monitoring the number of visitor page views in order to compensate the payee member 104. It will be appreciated that the disclosure and arrangement of FIG. 3 may be modified or re-arranged to best fit a particular implementation of the various embodiments of the invention.

The visitor may click on the link on the referring site 104 referring the visitor to the destination site 102 (whether embedded in the content or on the referring site as a widget) (block 300). The visitor may be directed to the destination site 102 (block 302).

Member data may be transmitted to the destination site 102 when the visitor is directed to the site 102 (block 304). As described above, the member data may be the payee member identifier such as a tracking code or a URL. The member data may be transmitted to the destination site one or more times. For example, the member data may be transmitted when the visitor begins a viewing session on the destination site. The member data may additionally or alternatively be transmitted with each page view during the browsing session.

The browsing/viewing session may be defined by when the destination site 102 is open and closed (e.g., opening and closing the window browser displaying the content of the destination site 102). A session may be “closed” when the browser window is closed or a different site is visited using the same browser window.

Once the visitor is on the destination site 102, the number of page views may be tracked by the system 100 and tabulated (block 306). Using the tabulated page view count, the monetary value of the visit by the visitor may be calculated (block 308). Details of the how the monetary value is calculated will be described below with respect to FIG. 4.

A determination may be made if the visit by the visitor is a re-visit (block 310). The process for identifying a visit as a re-visit is described above. Determining whether the visit is a re-visit may assist in determining if the payee 104 should continue to receive compensation for the visitor's visit. If a visitor re-visits the destination site 102 via the same referring site 104, the referring site 104 will be compensated as described above. In some instances, a visitor may visit the destination site 102 directly without visiting the referring site 104. For example, the visitor may visit the destination site 102 via the referring site 104 on a first visit, but a subsequent visit may be directly to the destination site 104. In this case, the referring site may still be compensated. Accordingly, a referring site 104 may be compensated in perpetuity for a visitor visiting the destination site 102. If the visitor re-visits the destination site 102 through an intervening referring site 104, the most recently visited referring site 104 may be compensated for the visit.

In some embodiments, there may be multiple referring sites 104 that may collectively refer a visitor to a destination site 102. For example, referring site A may refer the visitor to referring site B which includes a link or widget to the destination site 102. In this case, referring sites A and B may receive compensation. The indirect referring site 104 (in this example, referring site A) may have an identifier provided by the destination site 102 (e.g., and without limitation, a tracking code) which may be appended to the URL and/or tracking code of the direct referring site 104 (in this example, site B). In this way, the indirect referring site may be identified. In some embodiments, there may be multiple (e.g., at least two) identifiers associated with each payee 104. For example, a payee 104 may have an identifier to identify the payee as an indirect payee and an identifier to identify the payee as a direct payee. The identifier that may be transmitted to the destination site 102 for purposes of determining compensation to the referring site(s) may be determined by the referring site 104. The determination may be based on whether the visitor is directed to another member referring site 104 or the destination site 102. Thus, if the visitor is directed to a member referring site 104, the indirect identifier may be transmitted to the member referring site. The indirect identifier may be appended to the direct identifier (e.g., the identifier of the direct referring site) for transmission to the destination site. Transmission to the destination site 102 may occur (for example) by appending the identifier to the URL and/or identifier of the direct referring site.

In some embodiments, the portion of compensation given to the referring sites 104 may be based on the order of the referring sites 104 with respect to the destination site 102. For example, in the above example, site B, which directly refers the visitor to the destination site 102, may receive a greater share of the compensation than site A. Alternatively or additionally, site B may receive a part of the revenue based on the number of page views while site A may receive a smaller, fixed share or percentage. The fixed share may be the same for each referring site 104 or the amount may decrease based on the order of the referring site 104. Certainly, while the example illustrates two referring sites, there may be more referring sites. Further details of this multi-level compensation system will be described with respect to FIG. 4.

Referring back to FIG. 3, if the visit is not a re-visit (block 310), the payee's compensation may be calculated based on the single visit (block 312). The compensation calculation may occur on a periodic basis (e.g., daily, weekly, or monthly). Thus, if the compensation is calculated on a monthly basis, the payee's compensation may be based on the single visit during the month. The calculated compensation may be transmitted to the referring site (payee) 104 from the payor 102 (block 314).

If the visit is a re-visit (block 310), a determination may be made if there is an intervening referring site (payee) (block 316). This determination may determine which payee receives the compensation. If there is an intervening site, the most recently visited referring site is the intervening referring site (block 318). The compensation may be delivered to the most recently visited referring site. In either case, the page views may be counted for the visit (block 306) and the monetary value for the visit calculated (block 308). The payee's total compensation (accounting for the re-visit) may be calculated (block 312) and the compensation transmitted to the payee (block 314).

The process for calculating the amount of revenue shared with the referring site(s) 104 is shown in FIG. 4. It will be appreciated that the disclosure and arrangement of FIG. 4 may be modified or re-arranged to best fit a particular implementation of the various embodiments of the invention.

As described above, the revenue calculation may be performed by the revenue calculation software 114 on a periodic basis. At the end of every period, the advertisement revenue generated from the visits by the visitor may be received and/or calculated (block 400). As described above, this information may come from, or be based on information in, the advertisement data storage 124. The total number of pages viewed by visitors to the destination site 102 during the period may be determined (block 402).

A determination may be made if there is more than one payee 104 who referred the visitor to the destination 104 during the period (block 404). This payee determination may be made for payees who directly referred the visitor to the destination site 102. If so, the total number of pages viewed may be broken down based on the number of page views per payee (block 406). For example, if there are 100 page views during the month and three referring sites 104 which directed a visitor to the destination site 102, the individual contributions of each of the three referring site may be determined. For example, the referral from site A may have contributed to 60 page views, the referral from site B may have contributed to 20 page views, and the referral from site C may have contributed to 20 page views. The total revenue shared with each referring site 104 may be determined based on the number of page views that each site contributed due to the referral (block 408). It should be understood that the example above is for illustration purposes and is not to be considered limited to these values. The compensation to each payee may be delivered from the payor 102 to the payee(s) 104 (block 410). In some embodiments, a report of the compensation distribution may also be generated (block 412).

If there is a single payee for the period, the revenue to be shared with the payee 104 may be determined based on the total revenue generated for the period and the number of page views contributed by the payee 104 based on the referral (block 414). The compensation to the payee may be delivered from the payor 102 to the payee 104 (block 410). In some embodiments, a report of the compensation distribution may also be generated (block 412).

In some embodiments, a determination may be made if there are multiple levels of referring site 104 as described above (block 416). In this case, there may be implemented a multi-level compensation scheme. An example of such a multi-level referring site arrangement is described above. However, indirect referring sites (e.g., referring sites not directly referring the visitor to the destination site 102) do not necessarily need to be other online referring sites. For example, the indirect referring site 104 may be a brick-and-mortar entity, such as an advertising agency, that may register a direct referring site 104 (that is online) as a member of the syndication of referring sites 104. In this case, the identifier associated with the direct referring site may also include an identifier identifying the indirect brick-and-mortar referring site 104.

A referring site 104 may become an indirect referring site by sharing a link or widget with a potential referring site 104. For example, if site A hosts a widget with links to articles on the destination site 102, and a user visiting site A downloads the widget from site A to site B owned by the user (which directs a visitor to the destination site 102), then site A may also be compensated for the visit to the destination site by a visitor via site B. As described above, the indirect identifier may be transmitted to the destination site 102 identifying site A as an indirect referring site. It is not necessary that a referring site be either only a direct referring site or an indirect referring site. That is, in some instances, a referring site may be both an indirect referring site and a direct referring site.

In at least one instance, a referring site may “recruit” other referrers. This can be done through a variety of mediums, and typically will result in the recruited sites providing a link to the payor website (i.e., the final destination site). In order to encourage this behavior, referring websites that already have a referring account set up with the payor website may also have a code associated with their account. This code can be provided when a new referrer signs up, and can be used to associate the new referrer to an existing account. Then, when payment is calculated for the new referrer, some portion of the payment (or a fixed amount, etc.) can also be paid to the recruiting site. The payment can come from the money paid to the new referring site, or can be in addition to this money.

If there is no multi-level syndication of referring sites 104, the revenue share of the direct payee may be determined as described above (block 422). If there are multiple levels of referring sites 104, a portion of the revenue may be given to the indirect payees. The partial credit may be assigned to the indirect payees (block 418). As described above, the partial credit may be a fixed amount or a decreasing value (e.g., a percentage) per indirect payee 104. Based on the amount of credit given to the indirect payees 104, the share of revenue to the multi-level payee(s) may be determined (block 420). It will be appreciated that the share determination for the direct payee may be determined before, after, or concurrently with the share determination for the multi-level referring sites 104. In some embodiments, however, the compensation to the direct payee pay be determined and the balance may be distributed to the multi-level payees.

As described above, the share of revenue to the payees may be delivered to the payees (block 410). Delivery may or may not be electronic. For example, in some embodiments, the payor 102 may send the payee(s) 104 a check in the mail. Additionally, a report may be generated providing information including, but not limited to, total revenue generated for the period, revenue distribution information (including, but not limited to, amounts distributed, payees, and the like), and graphs.

As described above, one or more embodiments include a revenue sharing system and method. The system may include a destination site and one or more referring entities. The referring entity may direct a visitor to the destination site. In some embodiments, the referring entity may be an online referring site which directs the visitor to the destination site in response to a selection of a graphical button, such as a hyperlink. At the destination site, the number of page views by the visitor may be monitored and tabulated. The revenue generated by the destination site based on the visit from one or more visitors may be calculated. Based on the total revenue generated by the destination site, the revenue share for one or more referring sites may be calculated based on the number of page views by the visitor sent by the referring site(s). The revenue share for the referring site(s) may be transmitted to the referring site(s).

While exemplary embodiments are illustrated and described above, it is not intended that these embodiments illustrate and describe all possibilities. Rather, the words used in the specification are words of description rather than limitation, and it is understood that various changes may be made without departing from the spirit and scope of the invention.

I claim:

1. A revenue sharing system comprising:
a destination website in communication with an analytics module; and
a payment calculation module, capable of communication with the analytics module;
wherein one or more referring websites direct a visitor to the destination website in response to the selection of a link, wherein the analytics module tracks visitor activity and relates the activity to a referrer account, based on the link, and wherein the payment calculation module calculates a payment based at least in part on visitor activity, and wherein the destination website transmits the calculated payment to a payment account associated with the referrer account.

2. The system of claim 1, wherein the link is contained in a widget.

3. The system of claim 1, wherein the link is contained in a graphical button.

4. The system of claim 1, wherein the visitor activity includes tracking visitor revenue generation.

5. The system of claim 4, wherein the payment is based at least in part on revenue generation.

6. The system of claim 1, wherein the visitor activity includes a number of pages visited on a single visit.

7. The system of claim 1, wherein the visitor activity includes a number of pages visited on multiple visits.

8. The system of claim 7, wherein only the first of the multiple visits is directed from a referring website.

9. The method of claim 6, wherein the payment is based at least in part on the number of pages visited.

10. A computer-implemented method comprising:
receiving a request to access pages, at a destination website, from a visitor sent by a referring website;
tracking activity of the visitor on the destination website, and relating the tracked activity to a referrer account associated with the referring website;
calculating a payment for the referrer account, based on the tracked activity; and
transmitting the payment to a payment destination associated with the referrer account.

11. The method of claim 10, wherein the tracking includes tracking revenue generating activity.

12. The method of claim 11, wherein the payment is based at least in part on generated revenue.

13. The method of claim 10, wherein the tracking includes tracking a number of page visits.

14. The method of claim 13, wherein the payment is based at least in part on the number of page visits.

15. A computer implemented method comprising:
receiving a request from a party wishing to provide referrals to a website;
creating a new referrer account for the requesting party;
providing the requesting party with at least one link through which referrals may be generated;
tracking activity of visitors sent to the website via the at least one link;
calculating a payment to be rendered to the party based at least on tracked activity; and
remitting the calculated payment to the party.

16. The method of claim 15, further comprising:
receiving an account designation as part of the request;
finding an existing account that correlates to the received account designation;
inter-relating the new referrer account and the existing account, such that a predetermined portion of the calculated payment is added to a calculated payment for the existing account.

17. The method of claim 15, further comprising:
creating an account designation; and
providing the party with the account designation, for use in recruiting new referring parties.

18. The method of claim 15, wherein the tracking is performed by an analytics module in communication with the website.

19. The method of claim 15, wherein the at least one link is provided in the form of a widget.

20. The method of claim 15, wherein the at least one link is provided in the form of a graphic.
